(19) United States
(12) Patent Application Publication
(10) Pub. No.: US 2015/0161789 A1
(43) Pub. Date: Jun. 11, 2015

(54) SYSTEM AND METHOD FOR ADAPTIVE REGISTRATION OF VARYING CONTRAST-WEIGHTED IMAGES FOR IMPROVED TISSUE CHARACTERIZATION

(71) Applicants: Sébastien Roujol, Brookline, MA (US); Warren J. Manning, Natick, MA (US); Reza Nezafat, Newton, MA (US)

(72) Inventors: Sébastien Roujol, Brookline, MA (US); Warren J. Manning, Natick, MA (US); Reza Nezafat, Newton, MA (US)

(21) Appl. No.: 14/564,802

(22) Filed: Dec. 9, 2014

Related U.S. Application Data
(60) Provisional application No. 61/913,720, filed on Dec. 9, 2013.

(51) Int. Cl. G06T 7/00; G06K 9/46; G06K 9/62; G06T 7/20

(52) U.S. Cl. CPC G06T 7/0012; G06T 7/20; G06K 9/46; G06K 9/6215; G06T 2207/30004; G06T 2207/10088; G06K 2009/4666

(57) ABSTRACT

Systems and methods for adaptively registering images acquired with different contrast-weightings using a magnetic resonance imaging (“MRI”) system. For instance, motion is estimated as global affine motion refined by a local non-rigid motion estimation algorithm that simultaneously estimates the motion field and intensity variations among the images being registered. The images registered with the described systems and methods can be used for improved tissue characterization.

### CROSS-REFERENCE TO RELATED APPLICATIONS

This application claims the benefit of U.S. Provisional Patent Application Ser. No. 61/913,720, filed on Dec. 9, 2013, and entitled “System and Method for Adaptive Registration of Varying Contrast-Weighted Images for Improved Tissue Characterization.”

### STATEMENT REGARDING FEDERALLY SPONSORED RESEARCH

This invention was made with government support under EB008743 awarded by the National Institutes of Health. The government has certain rights in the invention.

### BACKGROUND OF THE INVENTION

The field of the invention is systems and methods for magnetic resonance imaging (“MRI”). More particularly, the invention relates to systems and methods for motion correction and image registration of images acquired with varying contrast weightings using an MRI system.

Tissue characterization techniques using MRI are invaluable tools for the assessment of a variety of diseases. These techniques acquire multiple images over a period of time with different contrast-weightings. For instance, images with T₁-weighting, T₂-weighting, T₂*-weighting, proton density weighting, or the like can be acquired over a period of time. In some embodiments, these images are acquired over a period of time spanning several heart beats. These images are then used to estimate tissue properties using pixel-wise model fitting.

Tissue characterization using MRI is currently performed without any motion correction in most commercial MRI scanners. One major limitation that reduces the applicability and reliability of tissue characterization techniques, however, is the presence of motion between each differently weighted image. This motion leads to significant error in tissue characterization.

Image-based motion correction algorithms can be used to reduce in-plane motion among images acquired with an MRI system. Although a variety of motion estimation algorithms have been proposed for medical image registration, few studies have addressed the problem of estimating motion between images having significantly varying contrast weightings. For instance, motion correction of T₁-weighted image series is challenging due to the high contrast variation among T₁-weighted images. Intensity-based approaches have been shown to fail due to the presence of high contrast variation and transient tissue nulling at certain inversion times.

As another example, some have attempted to use synthetic T₁-weighted images to simplify the registration problem in modified Look-Locker inversion recovery data acquisitions. But, the efficiency of this approach can be suboptimal—or this approach may even fail—in the presence of large motion.

It would therefore be desirable to provide systems and methods that address the motion during acquisitions that obtain varying contrast weightings to improve reliability, robustness, and accuracy of MRI-based tissue characterization.

### SUMMARY OF THE INVENTION

The present invention overcomes the aforementioned drawbacks by providing a system and method for estimating motion of a region-of-interest using a magnetic resonance imaging (“MRI”) system. A plurality of images acquired with an MRI system are provided. The plurality of images depict a subject. The motion of a region-of-interest in these images is estimated by computing motion parameters that maximize an image similarity metric in the region-of-interest between two of the plurality of images, such as a reference image and an image to be registered thereto. The motion parameters are refined by minimizing an optical flow functional that simultaneously estimates a motion field and intensity variations in the plurality of images.

The foregoing and other aspects and advantages of the invention will appear from the following description. In the description, reference is made to the accompanying drawings that form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a flowchart setting forth the steps of an example method for adaptive registration of varying contrast-weighted images for improved tissue characterization;

FIG. 2 is a block diagram of an example of a magnetic resonance imaging (“MRI”) system; and

FIG. 3 is a block diagram of a system that can implement some embodiments of the present disclosure.

### DETAILED DESCRIPTION OF THE INVENTION

Described here are systems and methods for adaptively registering images acquired with different contrast-weightings using a magnetic resonance imaging (“MRI”) system. For instance, motion is estimated as global affine motion refined by a novel local non-rigid motion estimation algorithm. The images registered with the described systems and methods can be used for improved tissue characterization.

The systems and methods described here incorporate a mathematical formulation and framework of the motion estimation problem that simultaneously estimate motion and intensity variation. This framework may include an extended formulation of an optical flow problem, and can integrate motion constraints based on automatic feature tracking. In some embodiments, the framework is a variational framework in which a motion field and intensity variations are simultaneously estimated, and in which an additional regularization term can be used to constrain a deformation field using automatic feature tracking.

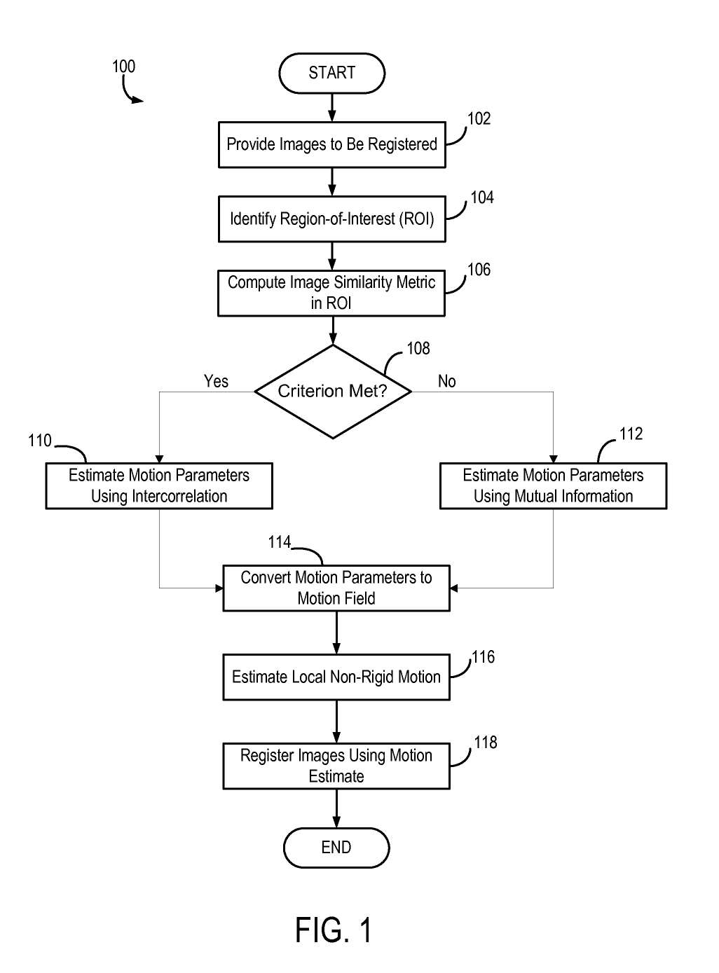

In general, the systems and methods of the present invention provide an image-based approach for Adaptive Registration of varying Contrast-weighted images for improved Tissue Characterization, which may be referred to as “ARCTIC.” A flowchart setting forth the steps of an example of such a technique is illustrated in FIG. 1.

First, images to be registered are provided, as indicated at step 102. As an example, the images can be provided by operating an MRI system to acquire a series of images. In some embodiments, more than one series of images can be acquired, each with a different contrast weighting. As another example, the images can be provided by retrieving one or more series of previously acquired images from a database or the like. As in the other example, the retrieved images may include more than one series of images each having a different contrast weighting.

A dense motion field is then estimated between each image to be registered and a reference image. As an example, the reference image can be selected as one of the provided images. For instance, the reference image can be selected as one of the images in a provided series of images, such as an image selected near the middle of each acquisition, which is favorable to minimize the motion amplitude to be estimated in the presence of drifting motion.

The dense motion field is generally estimated using a region-matching approach where a unique set of affine motion parameters is estimated to represent the motion of a region-of-interest (“ROI”). Thus, an ROI is first selected or otherwise identified in the images, as indicated at step 104. Preferably, the ROI is identified in the reference image. As an example, in some cardiac imaging applications, the ROI can be identified as the region that encompasses the endocardial border of the myocardium in cardiac imaging applications. In some embodiments, the ROI can be manually drawn.

A similarity criterion is used to determine how the affine motion parameters should be estimated for a given pair of images. For instance, the contrast similarity between images can be assessed. To this end, an image similarity metric is computed between the reference image and the image to be registered within the ROI, as indicated at step 106. As an example, the image similarity metric (C) can be computed using the following heuristic:

$$C = \vert 1 - \frac{{\sum }_{x , y} ( M ( x , y ) * {I}_{ref} ( x , y ) )}{{\sum }_{x , y} ( M ( x , y ) * {I}_{2 reg} ( x , y ) )} \vert \qquad [ 1 ]$$

where I_{ref} is the reference image, I_{2reg} is the image to be registered, and M is a reference binary mask set to 1 inside the ROI and 0 elsewhere.

The similarity metric is then compared with a criterion to determine how the affine motion parameters should be estimated, as indicated at decision block 108. As an example, for T₁-weighted images, the criterion can be whether the image similarity metric is less than or equal to a selected value, such as 0.8, that can be empirically selected.

If the criterion is satisfied, and the images are considered to have similar intensities or contrast, the affine motion parameters can be estimated using an inter-correlation coefficient (Eᵢₙₜ), as indicated at step 110. This inter-correlation coefficient can be computed using the following:

$${E}_{Int} = \frac{{\sum }_{x , y} ( M ( x , y ) * ( {I}_{ref} ( x , y ) - \overline{{I}_{ref}} ) * ( {I}_{2 reg} ( x , y ) - \overline{{I}_{2 reg}} ) )}{S * {σ}_{Iref} * {σ}_{I 2 reg}} \qquad [ 2 ]$$

where S is the number of pixels set to 1 in M, and (̅I̅_̅{̅r̅e̅f̅}̅; σ_{Iref}), ( I̅_̅{̅2̅r̅e̅g̅}̅, σ_{I2reg}) are the (averaged; standard deviation) of I_{ref} and I_{2reg} over all pixels satisfying M(x, y)=1, respectively.

If the criterion is not satisfied, and the images are considered to have dissimilar intensities or contrast, the affine motion parameters can be estimated using a mutual information (Eₘᵤₜ) metric, as indicated at step 112, which can be computed as follows:

$${E}_{Mut} = {\sum }_{{n}_{1} = 0}^{N} {\sum }_{{n}_{2} = 0}^{N} ( ρ ( {n}_{1} , {n}_{2} ) * log ( \frac{ρ ( {n}_{1} , {n}_{2} )}{{ρ}_{{I}_{ref}} ( {n}_{1} ) * {ρ}_{{I}_{ref}} ( {n}_{2} )} ) ) \qquad [ 3 ]$$

where ρ is the joint probability distribution function of the image intensity of I_{ref} and I_{2reg} and (ρ_{I}_{_{ref}}, ρ_{I}_{_{2reg}})are the marginal probability distribution functions of the image intensity of I_{ref} and I_{2reg}, respectively. The parameter N, which can be empirically set (e.g., to a value of 100), is the bin number of the histograms used for the calculation of ρ_{I}_{_{ref}}, ρ_{I}_{_{2reg}} and ρ. Note that, when using the mutual information, it may be advantageous to dilate the ROI using a local maximum operator (e.g., a disk structuring element with ray of 20 pixels) to improve the metric robustness.

In both step 110 and 112, the affine motion parameters can be estimated by maximizing the appropriate similarity metric, E_{Int} or E_{Mut}. As an example, the similarity metric can be maximized within the ROI using a sign gradient-descent with fixed steps to obtain the affine motion parameters.

The estimated set of affine motion parameters is then converted to a dense motion field, as indicated at step 114. As an example, the dense motion field can include one two-dimensional displacement vector per voxel. This dense motion field is used as an initialization of a local non-rigid motion estimation algorithm, which is used to refine the affine motion estimates, as indicated at step 116.

As will be described below, the local non-rigid motion estimates can be obtained using an extended formulation of the optical flow problem that simultaneously estimates motion field and intensity variation. In some embodiments, this formulation can also integrate the displacement of feature points as an additional regularization term.

Optical flow (“OF”) algorithms estimate dense motion fields by assuming intensity conservation during object displacements over time. Let I(x, y, t) be the image intensity of the reference image at voxel coordinates (x,y) at time t. The intensity conservation hypothesis leads to modeling the displacement (dx,dy) during time dt as,

I(x, y, t)=I(x+dx, y+dy, t+dt) [4]

The first-order Taylor series expansion about I(x, y, t) is,

I(x+dx, y+dy, t+dt)=I(x, y, t)+Iₓdx+I_{y}dy+Iₜddt+ε [5]

with (Iₓ, I_{y}, Iₜ)=(∂I/∂x, ∂I/∂yx, ∂I/∂t) and where ε represents the high order terms. Ignoring ε (which holds for small displacements) and combining equations [4] and [5] leads to the following optical flow equation:

Iₓu+I_{y}v+Iₜ=0 [6]

where (u, v)=(dx/dt , dy/dt) is the two-dimensional velocity field, or optical flow.

The intensity conservation hypothesis does not necessarily hold for MRI applications where the images may depict dramatic contrast/intensity variations due to different contrast weightings. Therefore, the intensity variation between images can be integrated into the motion model as follows:

I(x, y, t)+c(x, y, t)=I(x+dx, y+dy, t+dt) [7]

where c(x,y,t) is the pixel-wise intensity variation. Using equations [5] and [7], a modified formulation of the optical flow equation can be written as:

Iₓu+I_{y}v+Iₜ−c=0 [8]

Equation [8] has 3 unknowns (the two-dimensional motion field (u,v) and the intensity variation (c)) that need to be estimated. Therefore, to solve this ill-posed problem, additional constraints are used. In some embodiments, these additional constraints include constraining the spatial smoothness of both the motion field and intensity variation. The optical flow can then be estimated by minimizing the following functional:

$${E}_{CK} ( u , v , c ) = \int {\int }_{x , y} ( {‖ {I}_{x} u + {I}_{y} v + {I}_{t} - c ‖}_{2}^{2} + {α}^{2} ( {‖ ∇ u ‖}_{2}^{2} + {‖ ∇ v ‖}_{2}^{2} ) + {β}^{2} {‖ ∇ c ‖}_{2}^{2} ) d x d y \qquad [ 9 ]$$

where α is a weighting parameter designed to control the spatial smoothness of the motion field, β is a weighting parameter that controls the spatial smoothness of the intensity variation c, and ∇u=(du/dx, du/dy), ∇v=(dv/dx, dv/dy), and ∇c=(dc/dx, dc/dy).

To improve the robustness of the algorithm in the presence of transient structures induced by out-of-plane motion and specific tissue nulling at certain inversion times, an additional regularization term can be incorporated into Equation [9]. This additional regularization term can constrain the motion estimates using pre-estimated displacements of specific feature points.

To this end, feature points can be extracted by regular sampling of the ROI edges. Subsequently, the displacement of each feature point can be estimated using a region-matching approach restrained to a small ROI centered on each of these feature points. A simple two-dimensional translational model is estimated for each feature point to maintain the robustness of the estimation.

In some embodiments, the similarity metric used for this region matching can be based on the edge orientation coincidence function E_{edge} and is defined as,

$${E}_{edge} = \frac{{\sum }_{x , y} ( M ( x , y ) * ( S ( x , y ) * \frac{1 + cos ( 2 Δ θ )}{2} ) )}{{\sum }_{x , y} ( M ( x , y ) * S ( x , y ) )} \qquad [ 10 ]$$

where M is a binary mask set to 1 inside the feature point ROI and 0 elsewhere, S is the edge strength defined as S=\sqrt{Gx_{Iref}²+Gy_{Iref}²}*\sqrt{Gx_{I2reg}²+Gy_{I2reg}²,}Δθ is the edge orientation variation defined as Δθ=tan⁻(Gy_{Iref}/Gx_{Iref})−tan⁻¹(Gy_{I2reg}/Gx_{I2reg}), and (Gx_{Iref}, Gy_{Iref}, Gx_{I2reg}, Gy_{Ireg}) are the gradient magnitudes of the edge strength S in the x and y directions for the reference image and the image to be registered, respectively.

To speed up the convergence of the feature point tracking, the displacement of each feature point can be estimated using a global motion estimate as initialization. To remove occasional non-physiological motion estimates, an outlier rejection can be added.

In some embodiments, the motion estimates of the feature points can be assumed to follow a bivariate Gaussian distribution. A feature point can then be automatically discarded if at least one of its displacement components does not lie within three standard deviations of the averaged feature point displacements (marginal three-sigma rule). The displacement of these feature points is then integrated into a novel variation formulation of the optical flow problem as follows:

$${E}_{ARCTIC} ( u , v , c ) = \int {\int }_{x , y} ( {‖ {I}_{x} u + {I}_{y} v + {I}_{t} - c ‖}_{2}^{2} + {α}^{2} ( {‖ ∇ u ‖}_{2}^{2} + {‖ ∇ v ‖}_{2}^{2} ) + {β}^{2} {‖ ∇ c ‖}_{2}^{2} + {λ}^{2} {\sum }_{i = 1}^{N} ( F ( {d}_{i} ) [ {( u - {u}_{i} )}^{2} + {( v - {v}_{i} )}^{2} ] ) ) d x d y \qquad [ 11 ]$$

where (uᵢ, vᵢ) are the pre-estimated two-dimensional displacements of each feature point, N is the number of feature points, λ is a weighting parameter, and F(dᵢ) is a distance function defined as,

F(dᵢ)=exp(−d²/R²) [12]

where d represents the Euclidean distance between the pixel coordinates (x, y) and the i^{th} feature point, and R controls the spatial influence of each constraint point.

The optical flow is finally obtained by minimizing the functional E_{ARCTIC}(u, v, c) in Equation [11]. In some embodiments, this minimization can be performed using the calculus of variation and a Gauss-Seidel approach.

For example, the functional E_{ARCTIC}(u, v) can be minimized using the calculus of variation and by solving the associated Euler-Langrage equations. Using the Laplacian approximation defined as ∇²u=u−ū and ∇²v=v− v̅ with (ū, v̅) the average value of (u, v) in the neighborhood (3×3 pixels) of the estimated point, the following system of equations can be obtained:

$$\{ \begin{matrix}( {I}_{x}^{2} + {α}^{2} + {λ}^{2} S ) u + {I}_{x} {I}_{y} v - {I}_{x} c & = & - {I}_{x} {I}_{t} + {α}^{2} \overline{u} + {λ}^{2} {S}_{ui} \\ {I}_{x} {I}_{y} u + ( {I}_{y}^{2} + {α}^{2} + {λ}^{2} S ) v - {I}_{y} c & = & - {I}_{y} {I}_{t} + {α}^{2} \overline{v} + {λ}^{2} {S}_{vi} \\ - {I}_{x} u - {I}_{y} + ( {β}^{2} + 1 ) c & = & {I}_{t} + {β}^{2} c\end{matrix} \qquad [ 13 ]$$

where S=Σᵢ₌₁^{N}(ρ(dᵢ)), Sᵤᵢ=Σᵢ₌₁^{N}(ρ(dᵢ)uᵢ), and Sᵥᵢ=Σᵢ₌₁^{N}(ρ(dᵢ)vᵢ). This system can be solved using the Gauss-Seidel approach which provides the following iterative scheme:

$$\begin{matrix} \{ \begin{matrix}{u}^{n + 1} & = & \frac{{α}^{2} {\overline{u}}^{n} + {λ}^{2} {S}_{ui}^{n} - {A}^{n} {I}_{x}}{{α}^{2} + {λ}^{2} S} \\ {v}^{n + 1} & = & \frac{{α}^{2} {\overline{v}}^{n} + {λ}^{2} {S}_{vi}^{n} - {A}^{n} {I}_{y}}{{α}^{2} + {λ}^{2} S} \\ {c}^{n + 1} & = & {c}^{n} + \frac{{A}^{n}}{{β}^{2}}\end{matrix} \\ with & [ 14 ] \\ {A}^{n} = \frac{{I}_{x} ( {α}^{2} {\overline{u}}^{n} + {λ}^{2} {S}_{ui}^{n} ) + {I}_{y} ( {α}^{2} {\overline{v}}^{n} + {λ}^{2} {S}_{vi}^{n} ) + ( {I}_{t} - c ) ( {α}^{2} + {λ}^{2} S )}{{I}_{x}^{2} + {I}_{y}^{2} + {α}^{2} + {λ}^{2} S + ( {α}^{2} + {λ}^{2} S ) / {β}^{2}} & [ 15 ]\end{matrix}$$

In some embodiments, a multi-resolution approach can be used for the non-rigid motion estimation step. Using such an approach, the optical flow is initially estimated from sub-resolution images and then refined using the full resolution images.

The motion parameters estimated using the foregoing technique can then be used to register each corresponding image with the reference image, as indicated at step 118. Following this registration, tissue characterization techniques can be performed with greater reliability and accuracy than achievable without robust motion estimation and image registration.

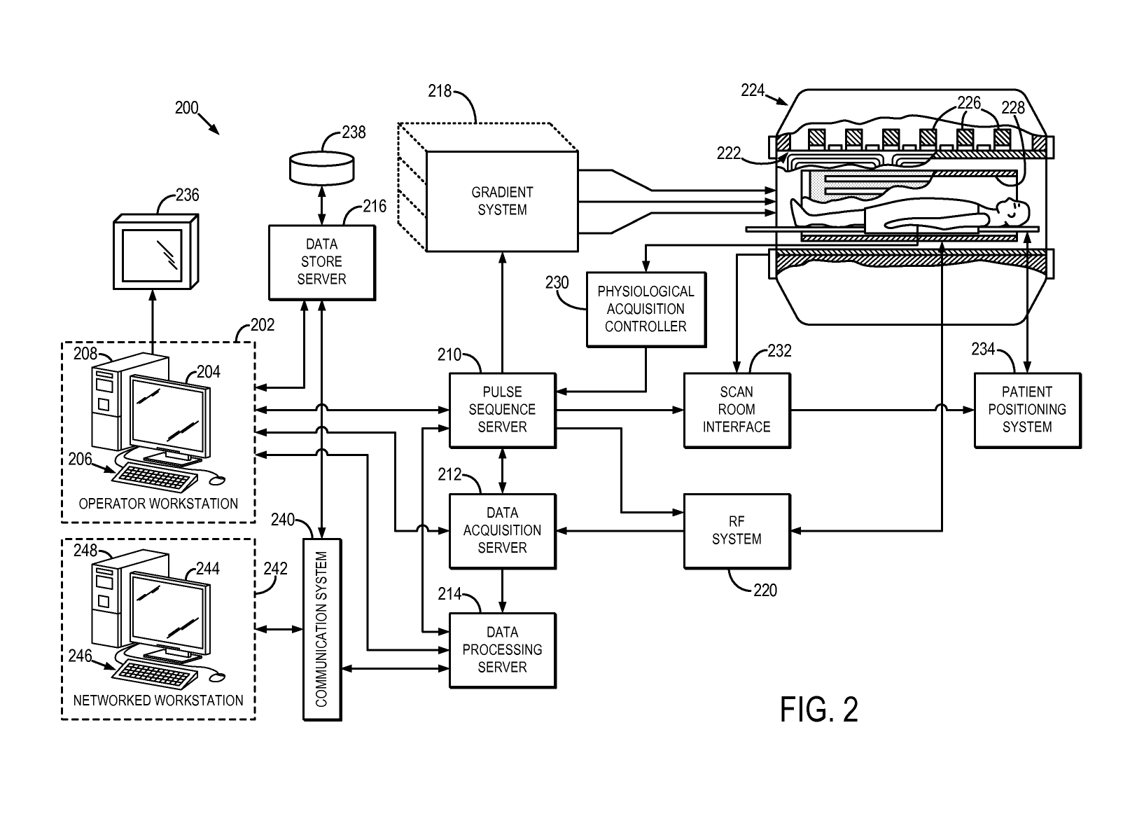

Referring particularly now to FIG. 2, an example of a magnetic resonance imaging (“MRI”) system 200 is illustrated. The MRI system 200 includes an operator workstation 202, which will typically include a display 204; one or more input devices 206, such as a keyboard and mouse; and a processor 208. The processor 208 may include a commercially available programmable machine running a commercially available operating system. The operator workstation 202 provides the operator interface that enables scan prescriptions to be entered into the MRI system 200. In general, the operator workstation 202 may be coupled to four servers: a pulse sequence server 210; a data acquisition server 212; a data processing server 214; and a data store server 216. The operator workstation 202 and each server 210, 212, 214, and 216 are connected to communicate with each other. For example, the servers 210, 212, 214, and 216 may be connected via a communication system 240, which may include any suitable network connection, whether wired, wireless, or a combination of both. As an example, the communication system 240 may include both proprietary or dedicated networks, as well as open networks, such as the internet.

The pulse sequence server 210 functions in response to instructions downloaded from the operator workstation 202 to operate a gradient system 218 and a radiofrequency (“RF”) system 220. Gradient waveforms necessary to perform the prescribed scan are produced and applied to the gradient system 218, which excites gradient coils in an assembly 222 to produce the magnetic field gradients Gₓ, G_{y}, and G_{z} used for position encoding magnetic resonance signals. The gradient coil assembly 222 forms part of a magnet assembly 224 that includes a polarizing magnet 226 and a whole-body RF coil 228.

RF waveforms are applied by the RF system 220 to the RF coil 228, or a separate local coil (not shown in FIG. 2), in order to perform the prescribed magnetic resonance pulse sequence. Responsive magnetic resonance signals detected by the RF coil 228, or a separate local coil (not shown in FIG. 2), are received by the RF system 220, where they are amplified, demodulated, filtered, and digitized under direction of commands produced by the pulse sequence server 210. The RF system 220 includes an RF transmitter for producing a wide variety of RF pulses used in MRI pulse sequences. The RF transmitter is responsive to the scan prescription and direction from the pulse sequence server 210 to produce RF pulses of the desired frequency, phase, and pulse amplitude waveform. The generated RF pulses may be applied to the whole-body RF coil 228 or to one or more local coils or coil arrays (not shown in FIG. 2).

The RF system 220 also includes one or more RF receiver channels. Each RF receiver channel includes an RF preamplifier that amplifies the magnetic resonance signal received by the coil 228 to which it is connected, and a detector that detects and digitizes the I and Q quadrature components of the received magnetic resonance signal. The magnitude of the received magnetic resonance signal may, therefore, be determined at any sampled point by the square root of the sum of the squares of the I and Q components:

M=\sqrt{I²+Q²} [16];

and the phase of the received magnetic resonance signal may also be determined according to the following relationship:

$$ϕ = {tan}^{- 1} ( \frac{Q}{I} ) . \qquad [ 17 ]$$

The pulse sequence server 210 also optionally receives patient data from a physiological acquisition controller 230. By way of example, the physiological acquisition controller 230 may receive signals from a number of different sensors connected to the patient, such as electrocardiograph (“ECG”) signals from electrodes, or respiratory signals from a respiratory bellows or other respiratory monitoring device. Such signals are typically used by the pulse sequence server 210 to synchronize, or “gate,” the performance of the scan with the subject's heart beat or respiration.

The pulse sequence server 210 also connects to a scan room interface circuit 232 that receives signals from various sensors associated with the condition of the patient and the magnet system. It is also through the scan room interface circuit 232 that a patient positioning system 234 receives commands to move the patient to desired positions during the scan.

The digitized magnetic resonance signal samples produced by the RF system 220 are received by the data acquisition server 212. The data acquisition server 212 operates in response to instructions downloaded from the operator workstation 202 to receive the real-time magnetic resonance data and provide buffer storage, such that no data is lost by data overrun. In some scans, the data acquisition server 212 does little more than pass the acquired magnetic resonance data to the data processor server 214. However, in scans that require information derived from acquired magnetic resonance data to control the further performance of the scan, the data acquisition server 212 is programmed to produce such information and convey it to the pulse sequence server 210. For example, during prescans, magnetic resonance data is acquired and used to calibrate the pulse sequence performed by the pulse sequence server 210. As another example, navigator signals may be acquired and used to adjust the operating parameters of the RF system 220 or the gradient system 218, or to control the view order in which k-space is sampled. In still another example, the data acquisition server 212 may also be employed to process magnetic resonance signals used to detect the arrival of a contrast agent in a magnetic resonance angiography (“MRA”) scan. By way of example, the data acquisition server 212 acquires magnetic resonance data and processes it in real-time to produce information that is used to control the scan.

The data processing server 214 receives magnetic resonance data from the data acquisition server 212 and processes it in accordance with instructions downloaded from the operator workstation 202. Such processing may, for example, include one or more of the following: reconstructing two-dimensional or three-dimensional images by performing a Fourier transformation of raw k-space data; performing other image reconstruction algorithms, such as iterative or backprojection reconstruction algorithms; applying filters to raw k-space data or to reconstructed images; generating functional magnetic resonance images; calculating motion or flow images; and so on.

Images reconstructed by the data processing server 214 are conveyed back to the operator workstation 202 where they are stored. Real-time images are stored in a data base memory cache (not shown in FIG. 2), from which they may be output to operator display 212 or a display 236 that is located near the magnet assembly 224 for use by attending physicians. Batch mode images or selected real time images are stored in a host database on disc storage 238. When such images have been reconstructed and transferred to storage, the data processing server 214 notifies the data store server 216 on the operator workstation 202. The operator workstation 202 may be used by an operator to archive the images, produce films, or send the images via a network to other facilities.

The MRI system 200 may also include one or more networked workstations 242. By way of example, a networked workstation 242 may include a display 244; one or more input devices 246, such as a keyboard and mouse; and a processor 248. The networked workstation 242 may be located within the same facility as the operator workstation 202, or in a different facility, such as a different healthcare institution or clinic.

The networked workstation 242, whether within the same facility or in a different facility as the operator workstation 202, may gain remote access to the data processing server 214 or data store server 216 via the communication system 240. Accordingly, multiple networked workstations 242 may have access to the data processing server 214 and the data store server 216. In this manner, magnetic resonance data, reconstructed images, or other data may exchanged between the data processing server 214 or the data store server 216 and the networked workstations 242, such that the data or images may be remotely processed by a networked workstation 242. This data may be exchanged in any suitable format, such as in accordance with the transmission control protocol (“TCP”), the internet protocol (“IP”), or other known or suitable protocols.

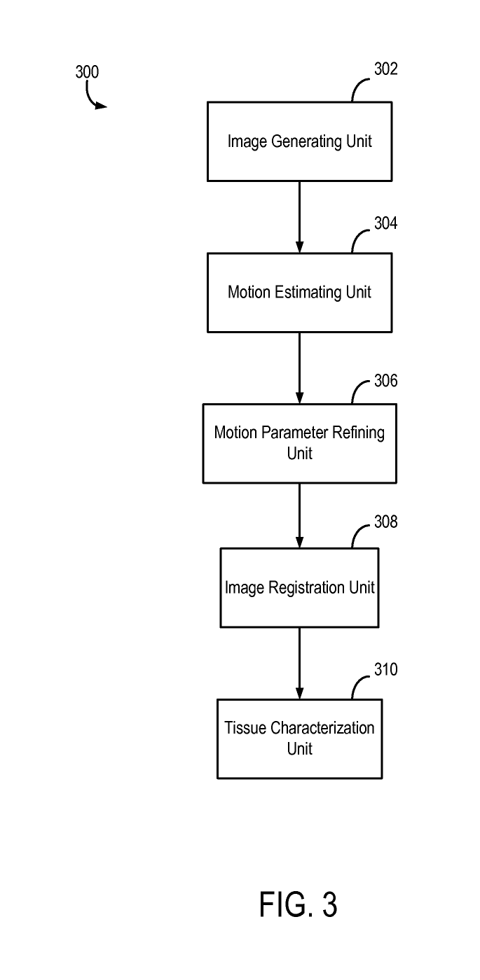

Referring now to FIG. 3, a system 300 is provided as an example of an implementation of a system that implements some of the embodiments of the present disclosure. An image generating unit 302 provides images acquired with an MRI system. In general, these provided images depict a subject. The image generating unit 302 can be part of the MRI system, a workstation, or a mobile device. The images may be T₁-weighted, T₂-weighted, T₂*-weighted, proton-density-weighted, dynamic-contrast-enhanced, and perfusion images. A motion estimating unit 304 then estimates motion of the subject by computing motion parameters that maximize an image similarity metric in the subject between two of the provided images. The two images may be a reference image and an image to be registered. Afterwards, a motion parameter refining unit 306 refines the motion parameters generated by the motion estimating unit 304 by minimizing an optical flow functional that simultaneously estimates a motion field and intensity variations in the images provided by the image generating unit 302.

In one configuration, the system 300 can include an image registration unit 308 that co-registers the images generated by the image generating unit 302 using the refined motion parameters generated by the motion parameter refining unit 306.

In some configurations, the system 300 can include a tissue characterization unit 310 that computes a tissue characterization parameter from the co-registered images generated by the image registration unit 308.

In some configurations, the motion estimating unit 304 can compute an image similarity heuristic in a region-of-interest for the two images, compare the image similarity heuristic to a criterion, and select an image similarity metric to maximize based on the comparison. For instance, the image similarity heuristic may be based on a contrast of the two images. When the comparison of the image similarity heuristic to the criterion indicates that the two images have similar contrast, the image similarity metric to maximize may be selected as an inter-correlation metric. On the other hand, when the comparison indicates that the two images have dissimilar contrast, the image similarity metric may be selected as a mutual information metric.

The motion parameter refining unit 306 can, in some configurations, convert the motion parameters estimated by the motion estimating unit 304 to a motion field, and refines the motion field. In some other configurations, the motion parameter refining unit 306 can regularize the optical flow functional based on displacement of feature points between the two images. For example, the feature points may be determined as points on a contour of a region-of-interest, and the displacement of the feature points may be estimated with a region-matching algorithm.

A novel approach for motion correction that is applicable to image series having varying contrast weightings has thus been provided. This technique can be used, in one example, to correct respiratory-induced motion occurring during breath-hold T₁ mapping sequences. The system and method provides excellent motion correction for both pre-contrast and post-contrast T₁ mapping, and significantly improves the quality of T₁ maps. In general, however, the technique described above can be used to correct motion in image series acquired with any one contrast weighting or, advantageously, multiple different image series acquired with multiple different contrast weightings.

Respiratory-induced motion and RR-interval variations represent the dominant components of the myocardial deformation/displacement in T₁-weighted images, or other images acquiring in cardiac imaging applications. However, patients being imaged during arrhythmic event may show high RR-interval variations which can lead to more complex deformation of the myocardium. The elastic nature of the local non-rigid motion estimation described above can be used to successfully account for respiratory-induced motion and RR-interval variations.

The same calibration of the weighting parameters (α, β, λ, R) can be used across all patients and all datasets, or, it is contemplated that personalized parameter calibration may further improve the registration. For example, reduced α values may allow for the estimation of more complex motion while higher α values may improve the robustness of motion estimates against noise. Because the noise level and the motion complexity encountered in dynamic anatomical regions, such as the myocardium, are patient-specific and acquisition-specific, a personalized calibration of the weighting parameters may improve registration performance. Furthermore, the use of robust estimators, such as the Lorentzian, instead of the L2 norm in the variational formulation of the optical flow problem may reduce the impact of outlier and lead to improved registration.

The present invention has been described in terms of one or more preferred embodiments, and it should be appreciated that many equivalents, alternatives, variations, and modifications, aside from those expressly stated, are possible and within the scope of the invention.

1. A method for estimating motion of a subject using a magnetic resonance imaging (MRI) system, the steps of the method comprising:
a) providing a plurality of images acquired with an MRI system, whereby the plurality of images depict a subject;
b) estimating motion of the subject by computing motion parameters that maximize an image similarity metric in the subject between two images of the plurality of images; and
c) refining the motion parameters by minimizing an optical flow functional that simultaneously estimates a motion field and intensity variations in the plurality of images.

2. The method as recited in claim 1, further comprising generating co-registered images by co-registering the plurality of images using the refined motion parameters.

3. The method as recited in claim 2, further comprising computing a tissue characterization parameter from the co-registered plurality of images.

4. The method as recited in claim 1, wherein step b) includes computing an image similarity heuristic in a region-of-interest for the two images of the plurality of images, performing a comparison of the image similarity heuristic to a criterion, and selecting an image similarity metric to maximize based on the comparison of the image similarity heuristic to the criterion.

5. The method as recited in claim 4, wherein the image similarity heuristic is based on a contrast of the two images of the plurality of images.

6. The method as recited in claim 5, wherein the image similarity metric to maximize is selected as an inter-correlation metric when the comparison of the image similarity heuristic to the criterion indicates that the two images of the plurality of images have similar contrast.

7. The method as recited in claim 5, wherein the image similarity metric to maximize is selected as a mutual information metric when the comparison of the image similarity heuristic to the criterion indicates that the two images of the plurality of images have dissimilar contrast.

8. The method as recited in claim 1, wherein step c) includes converting the motion parameters estimated in step b) to a motion field, and wherein refining the motion parameters comprises refining the motion field.

9. The method as recited in claim 1, wherein step c) includes regularizing the optical flow functional based on displacement of feature points between the two images of the plurality of images.

10. The method as recited in claim 9, wherein regularizing the optical flow functional includes determining the feature points as points on a contour of a region-of-interest, and estimating the displacement of the feature points using a region-matching algorithm.

11. The method as recited in claim 1, wherein the plurality of images includes at least one of T₁-weighted images, T₂-weighted images, T₂*-weighted images, proton-density-weighted images, dynamic-contrast-enhanced images, and perfusion images.

12. A system for estimating motion of a subject using a magnetic resonance imaging (MRI) system, comprising:
an image generating unit that provides a plurality of images acquired with an MRI system, whereby the plurality of images depict a subject;
a motion estimating unit that estimates the motion of the subject by computing motion parameters that maximize an image similarity metric in the subject between two images of the plurality of images; and
a motion parameter refining unit that refines the motion parameters by minimizing an optical flow functional that simultaneously estimates a motion field and intensity variations in the plurality of images.

13. The system as recited in claim 12, further comprising an image registration unit that generates co-registered images by co-registering the plurality of images using the refined motion parameters.

14. The system as recited in claim 13, further comprising a tissue characterization unit that computes a tissue characterization parameter from the co-registered images.

15. The system as recited in claim 12, wherein the motion estimating unit computes an image similarity heuristic in a region-of-interest for the two images of the plurality of images, performs a comparison of the image similarity heuristic to a criterion, and selects an image similarity metric to maximize based on the comparison of the image similarity heuristic to the criterion.

16. The system as recited in claim 15, wherein the image similarity heuristic is based on a contrast of the two images of the plurality of images.

17. The system as recited in claim 16, wherein the image similarity metric to maximize is selected as an inter-correlation metric when the comparison of the image similarity heuristic to the criterion indicates that the two images of the plurality of images have similar contrast.

18. The system as recited in claim 16, wherein the image similarity metric to maximize is selected as a mutual information metric when the comparison of the image similarity heuristic to the criterion indicates that the two images of the plurality of images have dissimilar contrast.

19. The system as recited in claim 12, wherein the motion parameter refining unit converts the motion parameters to a motion field and refines the motion field.

20. The system as recited in claim 12, wherein the motion parameter refining unit regularizes the optical flow functional based on displacement of feature points between the two images of the plurality of images.

21. The system as recited in claim 20, wherein the motion parameter refining unit determines the feature points as points on a contour of a region-of-interest, and estimates the displacement of the feature points using a region-matching algorithm when the motion parameter refining unit regularizes the optical flow functional.
